(19) United States
(12) Patent Application Publication
(10) Pub. No.: US 2015/0000297 A1
(43) Pub. Date: Jan. 1, 2015

(54) METHOD FOR DETERMINING AT LEAST ONE FIRING TEMPERATURE FOR CONTROLLING A GAS TURBINE AND GAS TURBINE FOR PERFORMING THE METHOD

(71) Applicant: ALSTOM Technology Ltd., Baden (CH)

(72) Inventors: Manuel ARIAS CHAO, Zurich (CH); Anton NEMET, Lengnau (CH); Ulrich Robert STEIGER, Baden-Dattwil (CH); Darrel Shayne LILLEY, Remetschwil (CH)

(21) Appl. No.: 14/491,172

(22) Filed: Sep. 19, 2014

Related U.S. Application Data
(63) Continuation of application No. PCT/EP2013/055925, filed on Mar. 21, 2013.

(30) Foreign Application Priority Data
Mar. 23, 2012 (EP) 12161134.7

(51) Int. Cl. F02C 9/28; F02C 7/12

(52) U.S. Cl. CPC F02C 9/28; F02C 7/12
USPC 60/772; 60/722

(57) ABSTRACT

The invention relates to a method for determining at least one firing temperature for controlling a gas turbine that comprises at least one compressor, at least one combustion chamber and at least one turbine, compressed air being drawn off at the compressor in order to cool the turbine and being fed to the turbine via at least one external cooling duct and via a control valve arranged in the cooling duct, in which method a plurality of temperatures and pressures of the working medium being measured in various positions of the gas turbine and the at least one firing temperature being derived from the measured temperatures and pressures. A more flexible and more accurate control is achieved additionally by determining the cooling air mass flow via the external cooling duct and by taking said flow into account when deriving the at least one firing temperature.

### CROSS-REFERENCE TO RELATED APPLICATIONS

This application claims priority to PCT/EP2013/055925 filed Mar. 21, 2013, which claims priority to European application 12161134.7 filed Mar. 23, 2012, both of which are hereby incorporated in their entireties.

### TECHNICAL FIELD

The present invention relates to the field of gas turbine technology. It relates to a method for determining at least one firing temperature for controlling a gas turbine according to the preamble of claim 1. It further relates to a gas turbine for carrying out the method.

### BACKGROUND

In the gas turbines which are customary today, the firing temperature is used as a control parameter under certain operating conditions (base load and partial load). Since continuous and precise direct measurements of the firing temperature cannot presently be made over the entire operational life of the gas turbine, for reasons of reliability, mechanical integrity and precision, the level of the firing temperature is determined from a multiplicity of measured process variables by means of a firing temperature determining method which is programmed into the gas turbine control logic.

Such a temperature determining method can be configured to determine the outlet temperature of the combustion chamber, the turbine inlet temperature, the turbine outlet temperature or any other temperature within the gas turbine related to the combustion, as is for example described in more detail in documents EP 1 231 369 A2 and EP 1 959 115 A2 and/or US 2010/050591 A1.

Progressive gas turbine operating concepts deal with the use of an adapted coolant supply when the gas turbine is in operation, as is disclosed for example in documents US 2004/0025491 A1 and US 2004/0221584 A1. Such a supply is generally effected by means of cooling air controlling valves. Two variants of such a supply are schematically reproduced in FIG. 1 and FIG. 2. The gas turbine 10 of FIG. 1 comprises a compressor 12, a combustion chamber 13 and a turbine 15 which drives the compressor 12 and a generator 16. In operation, ambient air 11 is sucked in by the compressor 12 where it is compressed and passed on to the combustion chamber 13, in which fuel is injected by means of a fuel supply line 14 and burnt using the compressed air. The resulting hot gas is expanded in the turbine 15 so as to perform work and, after it has left the turbine 15, is discharged to the outside via a chimney 19. In order to cool the turbine 15, compressed air is extracted from the compressor at various points and at various pressures and is supplied to the turbine 15 via cooling lines 17 and/or 18. In this context, the cooling air mass flow rates can be set by means of controlling valves V1 and V2. Cooling air can be released to the outside by means of blow-off valves V3 and V4.

The gas turbine 10′ of FIG. 2 is laid out as a gas turbine with sequential combustion and therefore comprises two combustion chambers 13a and 13b having two corresponding fuel supply lines 14a and 14b and two assigned turbines 15a and 15b. In the example represented, the second turbine 15b is supplied with cooling air from the compressor 12 via the cooling lines 17 and 18. The function of the valves V1-V4 is the same as in FIG. 1.

Controlling the firing temperature during operation with a set coolant supply while using the conventional firing temperature determining methods can, however, lead to undesirable discrepancies between the desired and actual firing temperatures, specifically because of the changing operating line of the gas turbine.

### SUMMARY

The invention is intended to provide a remedy here. The invention therefore has the object of proposing a method for determining at least one firing temperature for controlling a gas turbine, which method adequately takes into account the influence of an adjustable cooling of the turbine. The invention also has the object of providing a gas turbine for performing the method:

These and other objects are achieved by means of all the features of claims 1 and 6.

The method according to the invention proceeds from a gas turbine comprising at least one compressor, at least one combustion chamber and at least one turbine, wherein, for cooling the turbine, compressed air is extracted at the compressor and is fed to the turbine via at least one external cooling line and a controlling valve arranged in the cooling line. In this method a plurality of temperatures and pressures of the working medium are measured at various points in the gas turbine and the at least one firing temperature is derived from the measured temperatures and pressures. The method according to the invention is characterized in that, in addition, the cooling air mass flow rate through the external cooling line is determined and is taken into account when deriving the firing temperature.

According to one embodiment of the method according to the invention, the position of the controlling valve and the pressures upstream and downstream of the controlling valve are measured in order to determine the cooling air mass flow rate.

In particular, the controlling valve has a valve characteristic, wherein the valve characteristic is used for determining the cooling air mass flow rate.

Another embodiment of the method according to the invention is characterized in that, in addition, the water/steam content of the working medium is determined at various points in the gas turbine and is taken into account when deriving the firing temperature.

One development of this embodiment is characterized in that the firing temperature is determined according to the equation

$${T}_{x} = {f}_{1} ( {T}_{7} , \frac{{p}_{6}}{{p}_{7}} , {x}_{d} , \frac{{p}_{10}}{{p}_{11}} , {θ}_{1} )$$

where

f₁ is a function of first- and higher-order terms of the expressed variables,

T₇ denotes the temperature of the working medium at the turbine outlet,

p₆/p₇ is the quotient of turbine inlet pressure and turbine outlet pressure,

x_{d} denotes the water/steam content in the working medium,

p₁₀/p₁₁ is the quotient of the pressures upstream and downstream of the controlling valve in the cooling line, and

θ₁ characterizes the position of the controlling valve.

The gas turbine according to the invention for performing the method according to the invention comprises at least one compressor, at least one combustion chamber and at least one turbine, wherein, for cooling the turbine, compressed air is extracted at the compressor and is fed to the turbine via at least one external cooling line and a controlling valve arranged in the cooling line, wherein, at various points in the gas turbine, a plurality of measurement points are provided for measuring temperatures and pressures of the working medium and are connected, via assigned signal lines, to a controller which emits control signals for controlling the fuel supply to a fuel supply line to the combustion chamber. It is characterized in that means are provided for determining the cooling air mass flow rate through the external cooling line.

One embodiment of the gas turbine according to the invention is characterized in that measurement points for measuring the pressures upstream and downstream of the controlling valve, and for measuring the position of the controlling valve, are provided on the controlling valve and are connected to the controller via signal lines.

In particular, the controller is part of a closed control circuit for controlling a firing temperature of the gas turbine.

### BRIEF DESCRIPTION OF THE DRAWINGS

The invention will be explained in more detail below with reference to exemplary embodiments in conjunction with the drawing, in which:

FIG. 1 shows, in a simplified diagram, a gas turbine having a combustion chamber and a turbine, wherein the turbine is cooled using compressed air from the compressor via external cooling lines;

FIG. 2 shows, in a representation similar to FIG. 1, a gas turbine having sequential combustion and external cooling of the second turbine; and

FIG. 3 shows a gas turbine similar to FIG. 1 having external cooling of the turbine and control of a firing temperature taking into account the cooling air mass flow rate according to one exemplary embodiment of the invention.

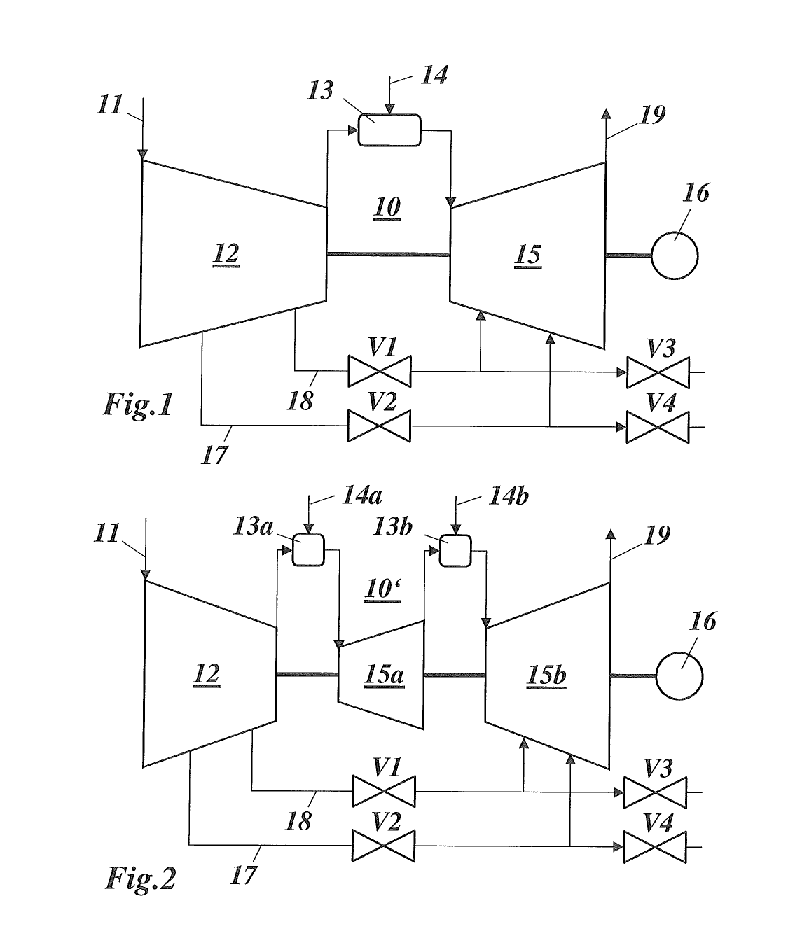

### DETAILED DESCRIPTION

The present invention deals with the use of controlling valve position measurements, pressure measurements upstream and downstream of the controlling valves, mass flow rate measurements of the coolant and/or valve characteristics as input variables for determining firing temperatures. Taking into account the advantages of firing temperature determining methods as disclosed in documents EP 1 231 369 A2 and EP 1 959 115 A2 and/or US 2010/050591 A1, in addition to the measurement variables used there, further measurements are taken into account, in particular the position of the controlling valves (in the cooling lines), the pressure ratios at the controlling valves and/or the corresponding valve characteristics.

While the influence of a cooling air mass flow rate which changes with the operating conditions (due to the surroundings and/or due to the load) has already been investigated in great detail and, for a fixed cooling air supply, is sufficiently well-known (see the cited EP 1 231 369 A2 and EP 1 959 115 A2 and/or US 2010/050591 A1), the position of the associated controlling valves, the pressures upstream and downstream of the controlling valves and the valve characteristics of the controlling valves have not hitherto been used, within the closed control loop, as input values for determining the firing temperature.

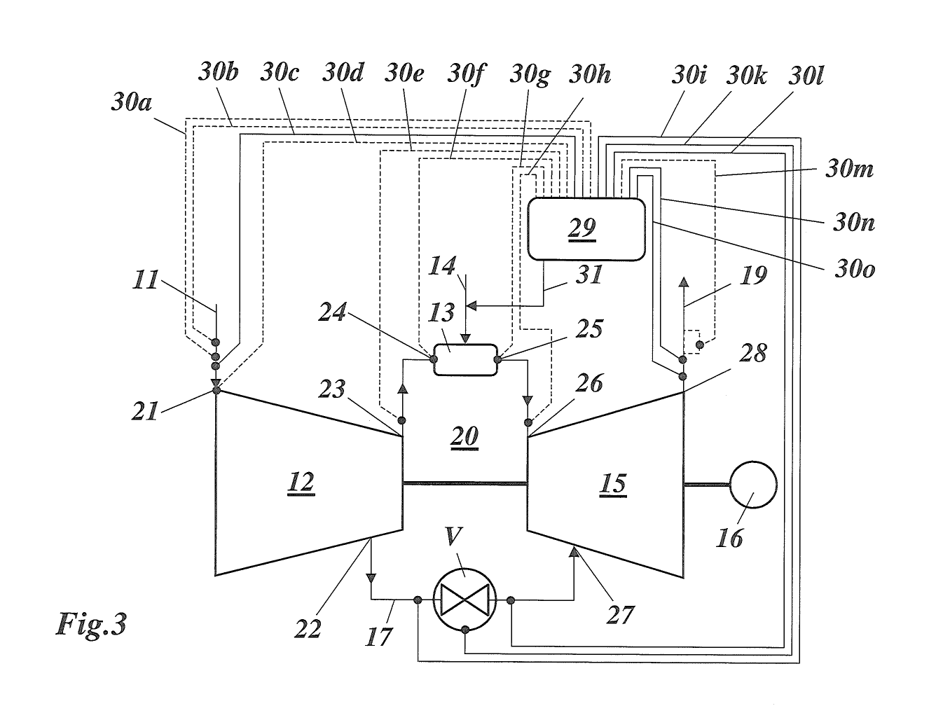

According to the exemplary embodiment represented in FIG. 3, the invention relates to a gas turbine 20 having at least one compressor 12, at least one combustion chamber 13 and at least one turbine 15. The turbine 15 is connected to the compressor 12 via at least one external cooling line 17. At least one controlling valve V is arranged in this cooling line 17 in order to control the cooling air mass flow rate.

Furthermore, at least one controller 29 is provided, by means of which, in a closed control loop, one or more firing temperatures are controlled using the method according to the invention, and to which measurement values are fed as input signals via corresponding signal lines 30a-o, which values are processed in the controller 29 and lead to control signals 31 by means of which (e.g. at the fuel supply line 14) the firing temperatures are adjusted. The controller 29 contains a controller computer which processes the multiplicity of measurement values for the temperatures and pressures of the working medium at various points in the gas turbine 20.

The following steps lead to the desired firing temperatures:
A multiplicity of temperatures of the working medium are measured at various points in the gas turbine.
A multiplicity of pressures of the working medium are measured at various points in the gas turbine.
The water content of the working medium is determined at various points in the gas turbine, as described in documents EP 1 959 115 A2 and/or US 2010/050591 A1. In this context, it is to be stressed that the measured moisture is not included directly as a correction factor in determining the firing temperature, but is merely used as a “calibration factor” for adapting the reference pressure at the turbine inlet as a consequence of aging-induced effects. The change in turbine inlet pressure as a function of all the injected water quantities—both inlet cooling and in the combustion chamber—is used as an actual correction term for determining the firing temperature. Proceeding therefrom, according to the invention, a punctualization is undertaken, according to which the change in turbine inlet pressure as a function of the moisture content relative to a reference value of the turbine inlet pressure is the actual correction factor. At the same time, the moisture information is now used for “calibrating” the aging-induced change in the reference value.
The position of the controlling valve (or valves) V in the cooling line 17 and the pressures upstream and downstream of the controlling valve (or valves) are measured.
The valve characteristic of the controlling valve (or valves) is prepared (reduced mass flow rate m_{red} or pressure loss coefficient ζ as a function of angular position and pressure drop).

According to the invention, the measurements of the controlling valve position, of the pressures upstream and downstream of the controlling valves, or measurements of the cooling air mass flow rate and/or valve characteristics are used to derive the firing temperatures. One or more firing temperatures in the gas turbine may automatically be set by the computer controller as a function of the operating point in the valve characteristic or, in other words, as a function of the cooling air mass flow rate. The influence of a change in the cooling air mass flow rate as a consequence of active control of the controlling valve is taken into account for the firing temperatures by a mathematical correlation in the algorithm of the control loop.

By including the changes in the cooling air mass flow rate when controlling the firing temperatures, it is possible to achieve improved control precision for the firing temperatures, and this over a broad range of environmentally-induced and load-induced operating conditions.

The following structure of the closed control loop is defined for controlling the firing temperatures. In that context, Tₓ denotes one or more firing temperatures which are controlled by the closed control in the gas turbine: The firing temperature Tₓ is determined according to the equation

$${T}_{x} = {f}_{1} ( {T}_{7} , \frac{{p}_{6}}{{p}_{7}} , {x}_{d} , \frac{{p}_{10}}{{p}_{11}} , {θ}_{1} )$$

where

f₁ is a function of first- and higher-order terms of the expressed variables,

T₇ denotes the temperature of the working medium at the turbine outlet,

p₆/p₇ is the quotient of turbine inlet pressure and turbine outlet pressure,

x_{d} denotes the water/steam content in the working medium,

p₁₀/p₁₁ is the quotient of the pressures upstream and downstream of the controlling valve (V) in the cooling line (17), and

θ₁ characterizes the position of the controlling valve (V).

For the quotient p₆/p₇, the following holds:

$$\frac{{T}_{6}}{{T}_{7}} = {( \frac{{p}_{6}}{{p}_{7}} )}^{\frac{n - 1}{n}} = {( \frac{{p}_{6}}{{p}_{7}} )}^{{η}_{p} \frac{κ - 1}{κ}}$$

where T₆ is the turbine inlet temperature, T₇ is the turbine outlet temperature and ηₚ is the polytropic turbine efficiency.

The inclusion of p₁₀/p₁₁ and θ₁ corresponds to the need to take into account the adapted coolant mass flow rate in the polytropic turbine efficiency ηₚ. The effect can be taken into account by the operating point of the cooling air controlling valve V (position θ₁ and pressure ratio p₁₀/p₁₁) in order to obtain the changes in the cooling air mass flow rate m₁₀ in the cooling air line with respect to a reference position of the controlling valve in a known cooling system.

The influence of m₁₀ in the variables p₆/p₇ and T₇ is as follows (m₂ denotes the mass flow rate of the aspirated ambient air 11):

$$\frac{{p}_{6}}{{p}_{7}} = {f}_{2} ( {m}_{10} / {m}_{2} ) and$$

$${T}_{7} = {f}_{3} ( {m}_{10} / {m}_{2} ) and$$

$$\frac{{p}_{6}}{{p}_{7}} = {g}_{2} ( \frac{{p}_{6}}{{p}_{{7}_{ref}}} , \frac{{p}_{10}}{{p}_{11}} , {θ}_{1} ) and$$

$${T}_{7} = {g}_{3} ( {T}_{ref} , \frac{{p}_{10}}{{p}_{11}} , {θ}_{1} ) ,$$

where f₂, f₃, g₂ and g₃ are represented functionally by first- and higher-order terms.

As shown in FIG. 3, the following measurement values are transmitted to the controller 29 via assigned signal lines 30a-o for the purpose of controlling the firing temperatures:
1. signal line 30a: ambient temperature T₁;
2. signal line 30b: ambient pressure p₁;
3. signal line 30c: compressor inlet temperature T₂;
4. signal line 30d: position of the adjustable inlet guide vanes □₁;
5. signal line 30e: compressor outlet pressure p₃;
6. signal line 30f: combustion chamber inlet pressure p₄;
7. signal line 30g: combustion chamber outlet pressure p₅;
8. signal line 30h: turbine inlet pressure p₆;
9. signal line 30i: pressure upstream of the controlling valve V, p₁₀;
10. signal line 30k: position of the controlling valve V, θ₁;
11. signal line 301: pressure downstream of the controlling valve V, p₁₁;
12. signal line 30m: ambient pressure p₁;
13. signal line 30n: turbine outlet temperature T₇; and
14. signal line 30o: turbine outlet pressure p₇.

The turbine outlet pressure p₇ can, in this context, also be replaced by the ambient pressure p₁ and the pressure loss from the turbine outlet to the chimney 19.

1. A method for determining at least one firing temperature for controlling a gas turbine having at least one compressor, at least one combustion chamber and at least one turbine; the method comprising:
for cooling the turbine, compressed air is extracted at the compressor and is fed to the turbine via at least one external cooling line and a controlling valve arranged in the cooling line, in which method a plurality of temperatures and pressures of the working medium are measured at various points in the gas turbine and the at least one firing temperature is derived from the measured temperatures and pressures, characterized in that, in addition, the cooling air mass flow rate through the external cooling line is determined and is taken into account when deriving the firing temperature.

2. The method as claimed in claim 1, wherein the firing temperature has a correction factor which is determined by the change in the turbine inlet pressure as a function of the moisture content relative to a reference value of the turbine inlet pressure.

3. The method as claimed in claim 2, wherein the moisture content is used for calibrating the aging-induced change in the reference value.

4. The method as claimed in claim 1, wherein the position of the controlling valve and the pressures upstream and downstream of the controlling valve are measured in order to determine the cooling air mass flow rate.

5. The method as claimed in claim 4, wherein the controlling valve has a valve characteristic, and in that the valve characteristic is used for determining the cooling air mass flow rate.

6. The method as claimed in claim 1, wherein the firing temperature is determined according to the equation
$${T}_{x} = {f}_{1} ( {T}_{7} , \frac{{p}_{6}}{{p}_{7}} , {x}_{d} , \frac{{p}_{10}}{{p}_{11}} , {θ}_{1} )$$
where f₁ is a function of first- and higher-order terms of the expressed variables, T₇ denotes the temperature of the working medium at the turbine outlet, p₆/p₇ is the quotient of turbine inlet pressure and turbine outlet pressure, x_{d} denotes the water/steam content in the working medium, p₁₀/p₁₁ is the quotient of the pressures upstream and downstream of the controlling valve in the cooling line, and θ₁ characterizes the position of the controlling valve.

7. A gas turbine for performing the method as claimed in claim 1 comprising at least one compressor, at least one combustion chamber and at least one turbine, wherein, for cooling the turbine, compressed air is extracted at the compressor and is fed to the turbine via at least one external cooling line and a controlling valve arranged in the cooling line, wherein, at various points in the gas turbine, a plurality of measurement points are provided for measuring temperatures and pressures of the working medium and are connected, via assigned signal lines, to a controller which emits control signals for controlling the fuel supply to a fuel supply line to the combustion chamber, characterized in that means are provided for determining the cooling air mass flow rate through the external cooling line.

8. The gas turbine as claimed in claim 7, wherein measurement points for measuring the pressures upstream and downstream of the controlling valve, and for measuring the position of the controlling valve, are provided on the controlling valve and are connected to the controller via signal lines.

9. The gas turbine as claimed in claim 7, wherein the controller is part of a closed control circuit for controlling a firing temperature of the gas turbine.
